(19) United States
(12) Patent Application Publication
(10) Pub. No.: US 2025/0334181 A1
(43) Pub. Date: Oct. 30, 2025

(54) SEALS WITH BELLOWS AND RELATED METHODS

(71) Applicant: Bal Seal Engineering, LLC, Foothill Ranch, CA (US)

(72) Inventors: Farshid Dilmaghanian, Orange County, CA (US); Robert Valdez, Santa Margarita, CA (US)

(73) Assignee: Bal Seal Engineering, LLC, Foothill Ranch, CA (US)

(21) Appl. No.: 19/095,220

(22) Filed: Mar. 31, 2025

Related U.S. Application Data
(60) Provisional application No. 63/638,998, filed on Apr. 26, 2024.
(60) Provisional application No. 63/638,976, filed on Apr. 26, 2024.

(51) Int. Cl. F16J 15/36

(52) U.S. Cl. CPC F16J 15/36

(57) ABSTRACT

A seal assembly with a housing having an outlet opening and a working component disposed therein for opening and closing the outlet opening to regulate fluid flow through the outlet opening. The working component can include a locking cap, seal element, a shaft, and a locking ring. The locking ring can optionally be integrated with the seal element.

### CROSS-REFERENCE TO RELATED APPLICATION

This is a regular utility application of U.S. Provisional Application No. 63/638,998, filed Apr. 26, 2024.

### FIELD OF ART

The present disclosure is generally related to seal assemblies for sealing a dynamic surface from fluid flow and more particularly to seal assemblies for applications with a movable shaft.

### BACKGROUND

Seal assemblies are known for use in static applications and dynamic applications. In dynamic applications, seals are used to maintain a constant seal around a dynamic object, such as a shaft, or for allowing flow and sealing from flow when the dynamic object actuates between positions.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a cross-sectional side view of a seal assembly provided in accordance with aspects of the invention.

FIG. 2 is a cross-sectional side view of another seal assembly provided in accordance with aspects of the invention.

FIG. 3 is a cross-sectional side view of another seal assembly provided in accordance with aspects of the invention.

FIG. 4 is a cross-sectional side view of another seal assembly provided in accordance with aspects of the invention.

FIG. 5 is a cross-sectional side view of another seal assembly provided in accordance with aspects of the invention.

FIG. 6 is a cross-sectional side view of another seal assembly provided in accordance with aspects of the invention.

FIG. 7 is a cross-sectional side view of another seal assembly provided in accordance with aspects of the invention.

FIG. 8 is a cross-sectional side view of another seal assembly provided in accordance with aspects of the invention.

### DETAILED DESCRIPTION

The detailed description set forth below in connection with the appended drawings is intended as a description of the presently preferred embodiments of seal assemblies provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

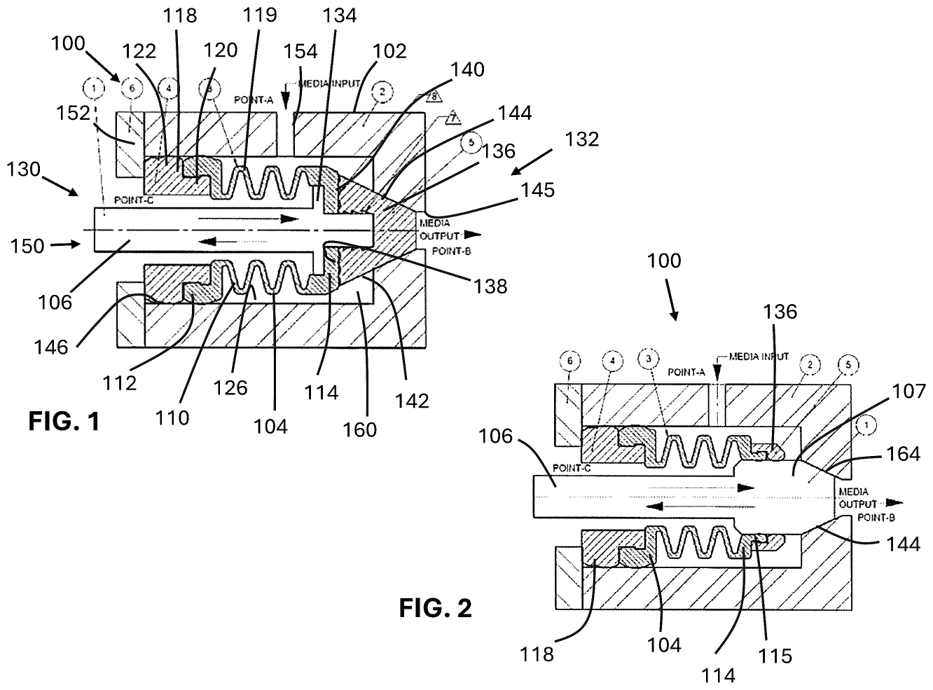

With reference now to FIG. 1, a cross-sectional side view of a seal assembly 100 provided in accordance with aspects of the invention is shown. The seal assembly has a housing 102 and a seal element 104 disposed around a shaft 106. The seal element 104 has a body 110 that is made from an elastomeric material or a thermoplastic elastomer, a plastomer, which has qualities of elastomers and plastics, or a polymeric plastic material. The body can have a plurality of folds 119, similar to bellows. The folds 119 facilitate compression and expansion of the body when the shaft 106 reciprocates by a driver, such as by a motor, an actuator, a linkage system, etc. The body has a base 112 and a tip 114. The base 112 has a cup-like configuration for fitting over a locking ring 118. In an alternative embodiment, the body can have a straight wall or a tapered wall that tapers inwardly from the base to the tip. The body of the seal element can still fold or collapse even in the absence of pre-formed bellows.

The locking ring 118 can have a projection 120 and a drum 122. The base 112 of the seal element 104 can seat over the projection 120 and the projection is sized and shaped to press the base against the internal wall surfaces 126 of the housing to seal radial surfaces of the base against the housing. In some examples, the base and the projection can latch. That is, the two can have stepped surfaces so that they engage during assembly, prior to installing inside the housing.

The drum 122 of the locking ring 118 is sized and shaped to press fit against the internal wall surfaces 126 of the housing, in an interference fit. This configuration helps to secure the seal element 104 in place during reciprocating action of the shaft 106. The locking ring has a central bore that is larger than the outer diameter of the shaft so that the two do not contact during service, as the shaft reciprocates relative to the locking ring.

The seal assembly 100 has a proximal end 130 and a distal end 132. The shaft 106 has a flange 134 near the distal end of the shaft to press against the inside of the tip 114 of the seal element. The flange can be unitarily formed with the shaft or can be separately formed and mounted to the shaft. A locking cap 136 is mounted at a tip end of the shaft, distal of the of the flange 134. The locking cap 136 is configured to press the tip 114 between an end surface 138 of the locking cap 136 and the flange 134 to form a seal therebetween. In an example, the locking cap 136 is held at the distal end of the shaft via press fit, barbs, threads, a set screw, or combinations thereof. In some examples, ridges or bumps 140 can be provided between the tip 114 and the end surface 138 of the locking cap to form pressure points for increased sealing forces of the tip against the flange. The locking cap 136 has a tapered seat 142 for pressing against a complementary tapered seat 144 at the outlet opening 145 of the housing opening and seals against the outlet opening during actuation of the shaft, as further discussed below.

The housing 102 has an assembly opening 146 at the proximal end 130. The assembly opening 146 allows the combination locking cap 136, seal element 104, shaft 106, and locking ring 118, which can be called the working components 150, to be inserted from the proximal end and slid within the housing towards the distal end. Thereafter, the working components 150 can be held in place with a housing plate 152. The housing plate 152 can be secured to the housing at the assembly opening using a number of different means, such as threads, fasteners, set screws, bonding, welding, or combinations thereof.

Depending on the applications, the various components may be made from any known number of materials, including plastics, engineered plastics, elastomers, plastomers, metals, and alloys.

An inlet opening 154 is provided in the housing, spaced from the outlet opening 145. In an example, the outlet opening is provided at the distal end of the housing while the inlet opening is provided on a side of the housing, between the proximal end and the distal end. In use, the seal chamber 160 is defined by the space between the interior of the housing 102 and the seal element 104 and is pressurized with a fluid through the inlet opening 154. The shaft is then retracted to allow the fluid to flow out of the outlet opening 145. In an alternative application, the shaft is first retracted to compress the bellows and to retract the seat of the locking cap from the seat at the outlet opening, fluid is then pushed through the inlet and out the outlet opening. In still yet another application, seal chamber 160 is under fluid pressure and fluid flow out the outlet is controlled by the frequency of actuation of the shaft and the length of actuation of the locking cap away from the outlet opening.

With reference now to FIG. 2, a seal assembly 100 in accordance with further aspects of the invention is shown. The present seal assembly 100 is similar to the seal assembly of FIG. 1 with a few exceptions. For example, the present embodiment comprises a housing and a locking ring 118. In the present embodiment, the locking cap 136 has been modified to retain the tip 114 of the seal element 104 without also serving as a seat to seal against the seat 144 of the outlet opening 145. The present locking cap 136 has a skirt that radially presses the seal projection 115 at the tip 114 against the tip 107 of the shaft to form a seal against the exterior surfaces at the tip 107.

In the example shown, the tip 107 of the shaft 106 is provided with a tapered surface 164 to seat against the tapered seat 144 of the outlet opening 145. The seal assembly may operate the same as discussed above for the seal assembly of FIG. 1.

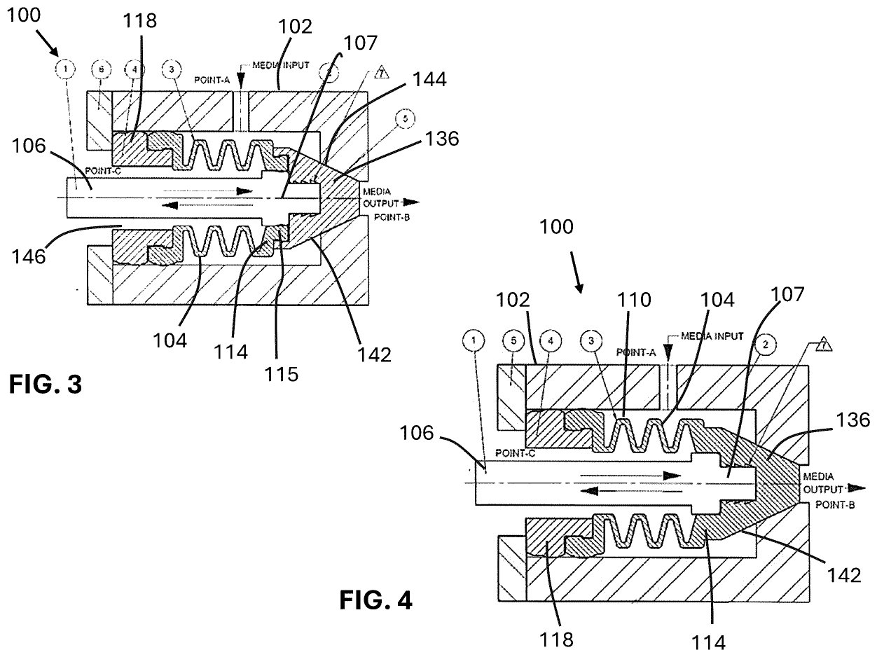

With reference now to FIG. 3, a seal assembly 100 in accordance with still further aspects of the invention is shown. The present seal assembly 100 is similar to the seal assembly of FIG. 1 and FIG. 2 with a few exceptions. In the present embodiment, the locking cap 136 has been modified to retain the tip 114 of the seal element 104 against the tip 107 of the shaft. Like the locking cap of FIG. 2, the present locking cap 136 has a skirt that presses the seal projection 115 at the tip 114 against the tip 107 of the shaft to form a seal against the exterior surfaces at the tip 107.

The present locking cap 136 also has a tapered a tapered surface or tapered seat 142 to seat against the tapered seat 144 of the outlet opening 145. The seal assembly may operate the same as discussed above for the seal assembly of FIG. 1.

With reference now to FIG. 4, a seal assembly 100 in accordance with still further aspects of the invention is shown. The present seal assembly 100 is similar to the seal assembly of FIGS. 1-3 with a few exceptions. In the present embodiment, the locking cap 136 is similar to the locking cap of FIGS. 1 and 3 but is integrated with the body 110 of the seal element 104. In other words, the seal element 104 can be unitarily formed with a body and a cap 136 and wherein the cap has a tapered seat to seat against the tapered seat 144 of the outlet opening 145. The seal assembly may operate the same as discussed above for the seal assembly of FIG. 1.

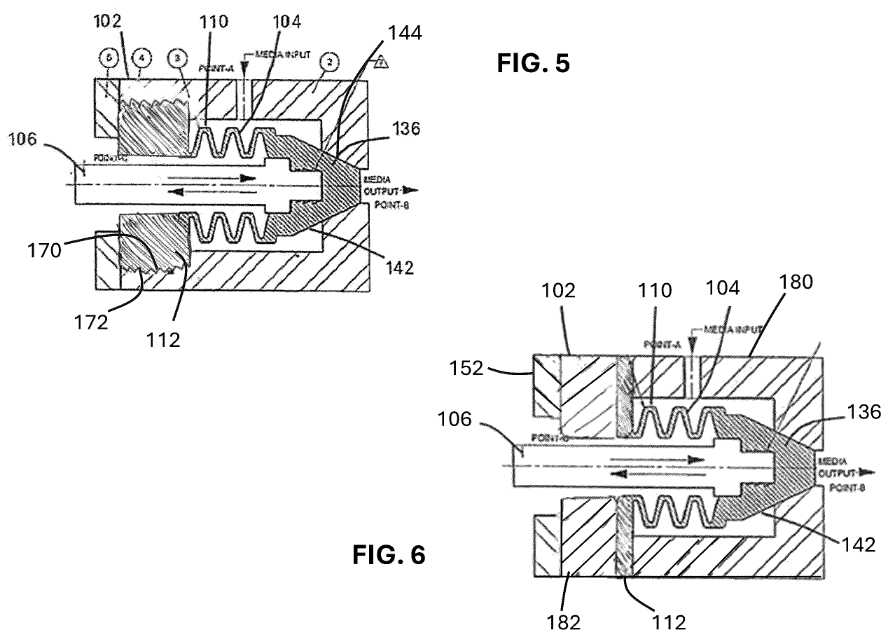

With reference now to FIG. 5, a seal assembly 100 in accordance with still further aspects of the invention is shown. The present seal assembly 100 is similar to the seal assembly of FIG. 4 with a few exceptions. In the present embodiment, the body 110 of the seal element 104 is unitarily formed with a base 112 that can anchor the seal element 104 within the interior of the housing 102. As shown, the base of the present embodiment has been enlarged compared to the base of FIG. 4. The base 112 can be solid and has a through bore for accommodating the shaft. In an example, the base incorporate threads 170 for threaded engagement with threads 172 on the housing. For example, the base can have exterior threads formed on the sidewall of the base for threaded engagement with interior threads formed in the interior of the housing. The housing can have a shoulder to delimit the distal movement of the base, when can determine the original seating position of the base and therefore the rest of the seal element, including the unitarily formed cap 136. The seal element with the unitarily formed base can be made from a thermoplastic material and/or thermoset types. Plastomers may also be used to form the seal element and base.

Like that of FIG. 4, the seal element 104 can be unitarily formed with a body and a cap 136 and wherein the cap has a tapered seat to seat against the tapered seat 144 of the outlet opening 145. The seal assembly may operate the same as discussed above for the seal assembly of FIG. 1.

With reference now to FIG. 6, a seal assembly 100 in accordance with still further aspects of the invention is shown. The present seal assembly 100 is similar to the seal assembly of FIGS. 4 and 5 with a few exceptions. In the present embodiment, the body 110 of the seal element 104 is unitarily formed with a base 112 that can anchor the seal element 104 within the interior of the housing 102. As shown, the base 112 of the present embodiment has a flange configuration compared to the enlarged base of FIG. 5. The flange 112 is sized and shaped to be compressed between the main housing section 180 of the housing 102 and a mounting block 182. The compression on the flange 112 forms a seal at the base of the seal element to prevent leakage. The mounting block 182 can be retained to the housing 102 by a housing plate 152, as previously disused.

The length of the mounting block 182 in the lengthwise axis can be controlled or selected to maintain an overall length on the housing 102 that is preferred or desired. For example, the length of the mounting block can be selected so that the length of the housing 102 of the present embodiment is the same as the length of the housing of FIG. 1.

Like that of FIG. 4, the seal element 104 can be unitarily formed with a body and a cap 136 and wherein the cap has a tapered seat to seat against the tapered seat 144 of the outlet opening 145. The seal assembly may operate the same as discussed above for the seal assembly of FIG. 1.

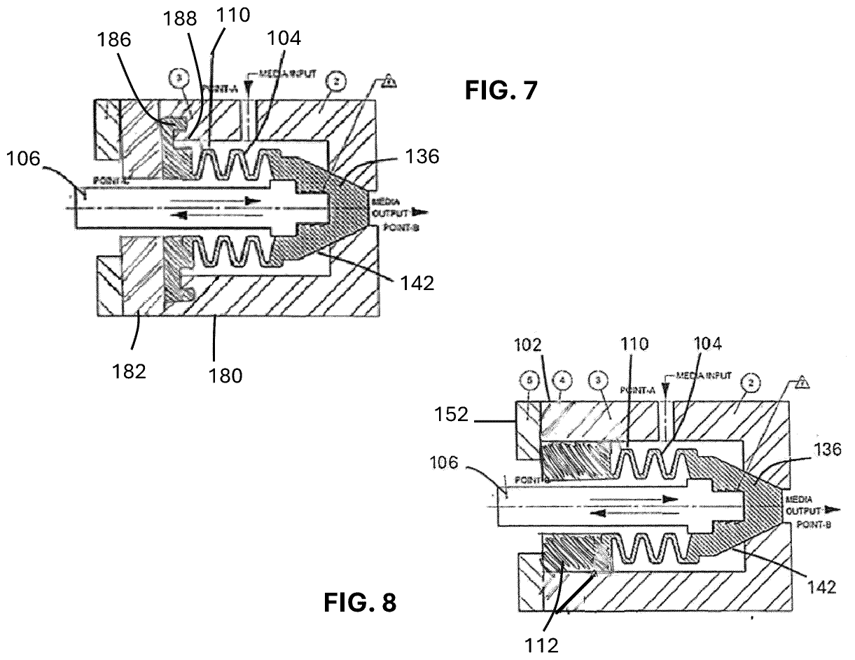

With reference now to FIG. 7, a seal assembly 100 in accordance with still further aspects of the invention is shown. The present seal assembly 100 is similar to the seal assembly of FIGS. 4-6 with a few exceptions. In the present embodiment, the body 110 of the seal element 104 is unitarily formed with a base 112 that can anchor the seal element 104 within the interior of the housing 102. As shown, the base 112 of the present embodiment has a flange configuration, similar to that of FIG. 6, with a notch 186. The housing 102 can have a corresponding or complementary notch 188 for mating engagement with the notch on the flange. The notch 188 on the housing also defines an axial stop for delimiting advancement of the flange 112 in the distal direction.

The flange 112 is sized and shaped to be compressed between the main housing section 180 of the housing 102 and a mounting block 182. The compression on the flange 112 forms a seal at the base of the seal element to prevent leakage, which sealing is further assisted by the interlocking notches 186, 188. The mounting block 182 can be retained to the housing 102 by a housing plate 152, as previously disused.

Like that of FIG. 4, the seal element 104 can be unitarily formed with a body and a cap 136 and wherein the cap has a tapered seat to seat against the tapered seat 144 of the outlet opening 145. The seal assembly may operate the same as discussed above for the seal assembly of FIG. 1.

With reference now to FIG. 8, a seal assembly 100 in accordance with still further aspects of the invention is shown. The present seal assembly 100 is similar to the seal assembly of FIGS. 4 and 5 with a few exceptions. In the present embodiment, the body 110 of the seal element 104 is unitarily formed with a base 112 that can anchor the seal element 104 within the interior of the housing 102. As shown, the base of the present embodiment has been enlarged compared to the base of FIG. 4 and similar to FIG. 5. The base 112 of the present embodiment can be solid and has a through bore for accommodating the shaft. In an example, the base incorporate an outer diameter for compression fit with the interior diameter of the housing 102. The compression fit seals the base against the housing and closes the fluid path therebetween. In some examples, the housing and the base can have a tapered fit so that when closed off by the housing plate 152, axial pressure is applied to tighten the tapered fit.

Like that of FIG. 4, the seal element 104 can be unitarily formed with a body and a cap 136 and wherein the cap has a tapered seat to seat against the tapered seat 144 of the outlet opening 145. The seal assembly may operate the same as discussed above for the seal assembly of FIG. 1.

In alternative examples, where the seat of the outlet opening 145 seals against the seat of the working component 150, whether it be of a locking cap or a tip of a shaft of the working component, the complementary surfaces can be other than tapered surfaces. For example, the seats can have curved surfaces, such as being arcuate or spherical, conical, or flat.

Methods of making and of using the seal assemblies described herein and components thereof are within the scope of the present invention.

Although limited embodiments of seal assemblies and their components have been specifically described and illustrated herein, many modifications and variations will be apparent to those skilled in the art. Accordingly, it is to be understood that seal assemblies and their components constructed according to principles of the disclosed device, system, and method may be embodied other than as specifically described herein. The disclosure is also defined in the following claims.

### EXAMPLE EMBODIMENTS

The following are numbered example embodiments of the apparatuses, devices, systems, and methods related to seal assemblies and components for forming the seal assemblies. Each seal assembly includes a housing, a seal element connected to a shaft and reciprocating by the shaft to move the seal element between an expanded configuration and a collapsed or compressed configuration. The seal assembly can be used to push pressurized fluid in a seal chamber defined by the housing interior and the seal element exterior out an outlet opening formed through the housing. Fluid can enter the seal chamber through an inlet opening formed through the housing. The examples identified below or any other examples disclosed herein may be combined in whole or in part, unless the context indicates otherwise. Elements of the examples disclosed herein, if applicable, are not limiting.

Example 1. A seal assembly comprising: a housing having an interior cavity, an outlet opening, an assembly opening, and an inlet opening, all spaced from one another; a working component is located in the interior cavity of the housing, the working component comprising a seal element having a plurality of folds and a shaft; and wherein the shaft is slidable relative to the housing to move the folds of the seal element between a compressed state and a less compressed state.

Example 2. The assembly, system, device, apparatus, and method of any of the above Examples alone or in combination, wherein the seal element has a tip and the shaft is abutted against the tip.

Example 3. The assembly, system, device, apparatus, and method of any of the above Examples alone or in combination, wherein a flange formed with the shaft is pushed against the tip of the seal element.

Example 4. The assembly, system, device, apparatus, and method of any of the above Examples alone or in combination, wherein the flange is unitarily formed with the shaft and has surfaces that extend radially of the lengthwise axis of the shaft.

Example 5. The assembly, system, device, apparatus, and method of any of the above Examples alone or in combination, further comprising a locking cap having a seat that is pushed against a complementary seat at the outlet opening of the housing.

Example 6. The assembly, system, device, apparatus, and method of any of the above Examples alone or in combination, wherein the locking cap is in contact with the tip of the seal element.

Example 7. The assembly, system, device, apparatus, and method of any of the above Examples alone or in combination, wherein the locking cap has a bore extending at least partially through the body of the locking cap.

Example 8. The assembly, system, device, apparatus, and method of any of the above Examples alone or in combination, wherein the shaft projects into the bore of the locking cap.

Example 9. The assembly, system, device, apparatus, and method of any of the above Examples alone or in combination, wherein the seat on the locking cap is tapered.

Example 10. The assembly, system, device, apparatus, and method of any of the above Examples alone or in combination, wherein the seat on the locking cap is arcuate or rounded.

Example 11. The assembly, system, device, apparatus, and method of any of the above Examples alone or in combination, wherein the seat on the locking cap is conical or flat.

Example 12. The assembly, system, device, apparatus, and method of any of the above Examples alone or in combination, wherein the seal element has a body with the plurality of folds and a base on an end opposite the tip of the seal element.

Example 13. The assembly, system, device, apparatus, and method of any of the above Examples alone or in combination, wherein the base of the seal element has a flange and a skirt.

Example 14. The assembly, system, device, apparatus, and method of any of the above Examples alone or in combination, further comprising a locking ring in contact with the base of the seal element.

Example 15. The assembly, system, device, apparatus, and method of any of the above Examples alone or in combination, wherein the seal element is made from a first material and the locking ring is made from a second material, different from the first material.

Example 16. The assembly, system, device, apparatus, and method of any of the above Examples alone or in combination, wherein the locking ring comprises a drum having a first OD and a projection extending from the drum having a second OD.

Example 17. The assembly, system, device, apparatus, and method of any of the above Examples alone or in combination, wherein the projection projects into the base of the seal element.

Example 18. The assembly, system, device, apparatus, and method of any of the above Examples alone or in combination, wherein the first OD of the drum is situated in the housing in a press fit arrangement.

Example 19. The assembly, system, device, apparatus, and method of any of the above Examples alone or in combination, wherein the locking ring has a through bore and the shaft slidable within the through bore.

Example 20. The assembly, system, device, apparatus, and method of any of the above Examples alone or in combination, wherein the through bore has an inside diameter that is larger than a diameter of the shaft.

Example 21. The assembly, system, device, apparatus, and method of any of the above Examples alone or in combination, wherein the housing has a first end, a second end opposite the first end, and a sidewall located between the first end and the second end.

Example 22. The assembly, system, device, apparatus, and method of any of the above Examples alone or in combination, wherein the outlet opening is at the first end of the housing and the inlet opening is at the second end of the housing.

Example 23. The assembly, system, device, apparatus, and method of any of the above Examples alone or in combination, further comprising a housing plate at the second end of the housing.

Example 24. The assembly, system, device, apparatus, and method of any of the above Examples alone or in combination, wherein the housing plate is secured to the housing.

Example 25. The assembly, system, device, apparatus, and method of any of the above Examples alone or in combination, wherein the housing plate is welded to the housing, is threaded to the housing, is fastened to the housing, is clamped to the housing, or combinations thereof.

Example 26. The assembly, system, device, apparatus, and method of any of the above Examples alone or in combination, wherein the housing plate has a through bore, and wherein the shaft is slidable within the through bore of the housing plate.

Example 27. The assembly, system, device, apparatus, and method of any of the above Examples alone or in combination, wherein the projection of the locking ring presses the base of the seal element against an interior surface of the housing.

Example 28. The assembly, system, device, apparatus, and method of any of the above Examples alone or in combination, wherein seal element has a body that is made from an elastomeric material, a thermoplastic elastomer, a plastomer, or a polymeric plastic material.

Example 29. The assembly, system, device, apparatus, and method of any of the above Examples alone or in combination, wherein the folds on the seal element facilitate compression and expansion of the body when the shaft reciprocates by a driver.

Example 30. The assembly, system, device, apparatus, and method of any of the above Examples alone or in combination, wherein the body of the seal element has a straight wall or a tapered wall that tapers inwardly from the base to the tip.

Example 31. The assembly, system, device, apparatus, and method of any of the above Examples alone or in combination, wherein the base of the seal element and the projection of the locking ring are latched to one another.

Example 32. The assembly, system, device, apparatus, and method of any of the above Examples alone or in combination, wherein the base and the projection latched with stepped surfaces so that they engage during assembly prior to installing inside the housing.

Example 33. The assembly, system, device, apparatus, and method of any of the above Examples alone or in combination, wherein the locking cap is held at the distal end of the shaft via a press fit, barbs, threads, a set screw, or combinations thereof.

Example 34. The assembly, system, device, apparatus, and method of any of the above Examples alone or in combination, wherein ridges or bumps are provided between the tip of the seal element and the end surface of the locking cap to form pressure points for increased sealing forces of the tip against the flange of the shaft.

Example 35. The assembly, system, device, apparatus, and method of any of the above Examples alone or in combination, wherein the shaft is retracted to allow fluid to flow out of the outlet opening.

Example 36. The assembly, system, device, apparatus, and method of any of the above Examples alone or in combination, wherein the shaft is retracted to compress the bellows and to retract the seat of the locking cap from the seat at the outlet opening to enable fluid to enter the inlet opening and then out the outlet opening.

Example 37. The assembly, system, device, apparatus, and method of any of the above Examples alone or in combination, wherein the seal chamber is under fluid pressure and fluid flows out the outlet is controlled by a frequency of actuation of the shaft and the length of actuation of the locking cap away from the outlet opening.

Example 38. A seal assembly comprising: a housing having an interior cavity, an outlet opening, an assembly opening, and an inlet opening, all spaced from one another; a working component is located in the interior cavity of the housing, the working component comprising a seal element having a body with a hollow cavity, a shaft, and a locking cap that presses a tip of the seal element against the shaft; and wherein the shaft is slidable relative to the housing to move the locking cap to a blocking configuration to block the outlet opening and to move the locking cap to an unblocking configuration to not block the outlet opening.

Example 39. The assembly, system, device, apparatus, and method of any of the above Examples alone or in combination, wherein the body of the seal element comprises a plurality of folds or bellows.

Example 40. The assembly, system, device, apparatus, and method of any of the above Examples alone or in combination, wherein the locking cap has a tapered seat and the outlet opening has a corresponding tapered seat.

Example 41. The assembly, system, device, apparatus, and method of any of the above Examples alone or in combination, wherein the body of the seal element and the locking cap are unitarily formed.

Example 42. The assembly, system, device, apparatus, and method of any of the above Examples alone or in combination, wherein the shaft has a tip with a seat that presses against a seat at the outlet opening of the housing.

Example 43. The assembly, system, device, apparatus, and method of any of the above Examples alone or in combination, wherein the shaft is made from a metal material.

Example 44. The assembly, system, device, apparatus, and method of any of the above Examples alone or in combination, wherein the seat at the outlet opening has a pliable material integrated into the housing, said pliable material having a through opening.

Example 45. A seal assembly comprising: a housing having an interior cavity, an outlet opening, an assembly opening, and an inlet opening, all spaced from one another; a working component is located in the interior cavity of the housing, the working component comprising a seal element having a body with a hollow cavity, a shaft, and a locking cap that presses a tip of the seal element against the shaft; and wherein the shaft is slidable relative to the housing to move a tip of the shaft to a blocking configuration to block the outlet opening and to move the tip of the shaft to an unblocking configuration to not block the outlet opening.

Example 46. The assembly, system, device, apparatus, and method of any of the above Examples alone or in combination, wherein the tip of the shaft has a tapered seat and the outlet opening has a corresponding tapered seat.

Example 47. The assembly, system, device, apparatus, and method of any of the above Examples alone or in combination, wherein the locking cap is disc-shaped with an opening and a skirt.

Example 48. The assembly, system, device, apparatus, and method of any of the above Examples alone or in combination, wherein the locking cap presses a tip of the seal element against the tip of the shaft.

Example 49. A seal assembly comprising: a housing having an interior cavity, an outlet opening, an assembly opening, and an inlet opening, all spaced from one another; a working component is located in the interior cavity of the housing, the working component comprising a seal element having a body with a hollow cavity and a shaft; and wherein the shaft is slidable relative to the housing to move the seal element between a compressed state and a less compressed state; and wherein the seal element has an integrated cap with a tapered seat and the outlet opening has a corresponding tapered seat.

Example 50. The assembly, system, device, apparatus, and method of any of the above Examples alone or in combination, wherein the seal element and the cap with the tapered seat are unitarily formed.

Example 51. The assembly, system, device, apparatus, and method of any of the above Examples alone or in combination, wherein the locking cap comprises a skirt and the seal element has a seal projection located within the skirt of the locking cap.

Example 52. The assembly, system, device, apparatus, and method of any of the above Examples alone or in combination, wherein the shaft has a radial projection and the radial projection is located in the tip of the seal element.

Example 53. The assembly, system, device, apparatus, and method of any of the above Examples alone or in combination, wherein locking cap comprises a skirt and the seal element has a seal projection that is latched to the skirt of the locking cap.

Example 54. A seal assembly comprising: a housing having an interior cavity, an outlet opening, an assembly opening, and an inlet opening, all spaced from one another; a working component is located in the interior cavity of the housing, the working component comprising a shaft located within a seal element having a body with a hollow interior and a base; wherein the shaft is slidable relative to the housing to move the folds of the seal element between a compressed state and a less compressed state; and wherein the base has an outside diameter that is threaded to the housing or is compressed against the housing.

Example 55. The assembly, system, device, apparatus, and method of any of the above Examples alone or in combination, wherein the seal element is unitarily formed with a cap having a tapered seat and the outlet opening has a corresponding tapered seat.

Example 56. The assembly, system, device, apparatus, and method of any of the above Examples alone or in combination, wherein the housing has a recessed bore section with female threads.

Example 57. The assembly, system, device, apparatus, and method of any of the above Examples alone or in combination, wherein the base of the seal element has male threads that thread against the female threads on the housing.

Example 58. A seal assembly comprising: a housing having an interior cavity, an outlet opening, an assembly opening, and an inlet opening, all spaced from one another; a working component is located in the interior cavity of the housing, the working component comprising a shaft located within a seal element having a body with a hollow interior and a base; wherein the shaft is slidable relative to the housing to move the folds of the seal element between a compressed state and a less compressed state; and wherein the base is a flange that is compressed between an end surface of the housing and a mounting block.

Example 59. The assembly, system, device, apparatus, and method of any of the above Examples alone or in combination, wherein the seal element is unitarily formed with a cap having a tapered seat and the outlet opening has a corresponding tapered seat.

Example 60. The assembly, system, device, apparatus, and method of any of the above Examples alone or in combination, wherein the mounting block has an outside diameter that is approximately equal to an outside diameter of the housing.

Example 61. The assembly, system, device, apparatus, and method of any of the above Examples alone or in combination, wherein the mounting block is made from a material that differs from the material of the sealing element.

Example 62. The assembly, system, device, apparatus, and method of any of the above Examples alone or in combination, wherein the mounting block is made from a material that differs from the material of the housing.

Example 63. The assembly, system, device, apparatus, and method of any of the above Examples alone or in combination, wherein the flange of the base has on outside diameter that is approximately equal to an outside diameter of the housing.

Example 64. The assembly, system, device, apparatus, and method of any of the above Examples alone or in combination, wherein the seal element has a body with a plurality of folds or bellow, a base that has a flange, and a locking cap that is unitarily formed with the body.

Example 65. A seal assembly comprising: a housing having an interior cavity, an outlet opening, an assembly opening, and an inlet opening, all spaced from one another; a working component is located in the interior cavity of the housing, the working component comprising a shaft located within a seal element having a body with a hollow interior and a base; wherein the shaft is slidable relative to the housing to move the folds of the seal element between a compressed state and a less compressed state; and wherein the base is a flange comprising a notch that is compressed against the housing by a mounting block.

Example 66. The assembly, system, device, apparatus, and method of any of the above Examples alone or in combination, wherein the housing has a notch, and wherein the notch of the flange engages the notch of the housing.

Example 66. The assembly, system, device, apparatus, and method of any of the above Examples alone or in combination, wherein the seal element is unitarily formed with a cap having a tapered seat and the outlet opening has a corresponding tapered seat.

Example 67. The assembly, system, device, apparatus, and method of any of the above Examples alone or in combination, wherein the outlet opening has a seat and the working components has a seat, and wherein the two seats are configured to form a seal when the two seats contact.

Example 68. The assembly, system, device, apparatus, and method of any of the above Examples alone or in combination, wherein the two seats have complementary tapered surfaces, complementary arcuate surfaces, or complementary flat surfaces.

Example 69. The assembly, system, device, apparatus, and method of any of the above Examples alone or in combination, wherein the seal element has a base, and wherein the base of the seal element comprises an outside diameter that is located in the housing in a press fit with the housing.

Example 70. A method of forming a seal assembly comprising: placing a working component into an interior cavity of a housing, the housing comprising an outlet opening, an assembly opening, and an inlet opening, all spaced from one another; wherein the working component comprising a seal element having a body with a hollow interior, a shaft, and a locking cap that presses a tip of the seal element against the shaft; and arranging the shaft to be slidable relative to the housing; and wherein the shaft is configured to move a tapered seat at a tip of the shaft to a blocking configuration to block the outlet opening and to move the tip of the shaft to an unblocking configuration to not block the outlet opening.

What is claimed is:

1. A seal assembly comprising:
a housing having an interior cavity, an outlet opening, an assembly opening, and an inlet opening, all spaced from one another;
a working component is located in the interior cavity of the housing, the working component comprising a seal element having a body with a hollow interior and a shaft; and
wherein the shaft is slidable relative to the housing to move the seal element between a compressed state and a less compressed state.

2. The seal assembly of claim 1, wherein the body has a plurality of folds or bellows.

3. The seal assembly of claim 2, wherein the shaft has a radial projection pressed against the seal element and a tip section located distally of the radial projection.

4. The seal assembly of claim 1, further comprising a locking cap pressed against the seal element and against the outlet opening.

5. The seal assembly of claim 1, wherein the locking cap has a tapered seat and the tapered seat of the locking cap is pressed against a seat on the housing.

6. The seal assembly of claim 1, wherein the seal element has a tip and the shaft is abutted against the tip.

7. The seal assembly of claim 1, wherein a flange is formed with the shaft and the flange is pushed against a tip of the seal element.

8. The seal assembly of claim 1, further comprising a locking cap having a seat that is pushed against a complementary seat at the outlet opening of the housing.

9. The seal assembly of claim 8, wherein the locking cap has a bore extending at least partially through a body of the locking cap.

10. The seal assembly of claim 9, wherein the shaft projects into the bore of the locking cap.

11. The seal assembly of claim 10, wherein the seat on the locking cap is tapered, arcuate, rounded, conical or flat.

12. The seal assembly of claim 1, wherein a base of the seal element has a flange and a skirt.

13. The seal assembly of claim 12, further comprising a locking ring in contact with the base of the seal element.

14. The seal assembly of claim 1, wherein the seal element is made from a first material and the locking ring is made from a second material, different from the first material.

15. The seal assembly of claim 13, wherein the locking ring comprises a drum having a first OD and a projection extending from the drum having a second OD.

16. The seal assembly of claim 13, wherein the projection projects into the base of the seal element.

17. The seal assembly of claim 15, wherein the first OD of the drum is situated in the housing in a press fit arrangement.

18. A seal assembly comprising:
a housing having an interior cavity, an outlet opening, an assembly opening, and an inlet opening, all spaced from one another;
a working component is located in the interior cavity of the housing, the working component comprising a seal element having a plurality of folds, a shaft, and a locking cap that presses a tip of the seal element against the shaft; and
wherein the shaft is slidable relative to the housing to move the locking cap to a blocking configuration to block the outlet opening and to move the locking cap to an unblocking configuration to not block the outlet opening.

19. The seal assembly of claim 18, wherein the locking cap has a tapered seat and the outlet opening has a corresponding tapered seat.

20. A method of forming a seal assembly comprising:
placing a working component into an interior cavity of a housing, the housing comprising an outlet opening, an assembly opening, and an inlet opening, all spaced from one another;
wherein the working component comprising a seal element having a body with a hollow interior, a shaft, and a locking cap that presses a tip of the seal element against the shaft; and
arranging the shaft to be slidable relative to the housing; and
wherein the shaft is configured to move a tapered seat at a tip of the shaft to a blocking configuration to block the outlet opening and to move the tip of the shaft to an unblocking configuration to not block the outlet opening.
